(19) United States
(12) Patent Application Publication
(10) Pub. No.: US 2026/0222361 A1
(43) Pub. Date: Jul. 30, 2026

(54) BANDWIDTH ASSIGNMENT AND FEATURE DETERMINATION METHOD, OPTICAL LINE TERMINAL, COMPUTING SERVER, AND MEDIUM

(71) Applicant: ZTE CORPORATION, Shenzhen, Guangdong (CN)

(72) Inventor: Hongxi ZHANG, Shenzhen (CN)

(21) Appl. No.: 19/144,745

(22) PCT Filed: Dec. 19, 2023
(86) PCT No.: PCT/CN2023/139797

§ 371 Date: Jun. 30, 2025

(30) Foreign Application Priority Data
Dec. 29, 2022 (CN) 202211706772.8

(51) Int. Cl. H04L 47/76; H04L 41/0896

(52) U.S. Cl. CPC H04L 47/76; H04L 41/0896

(57) ABSTRACT

The present disclosure provides a bandwidth assignment method, including: determining feature information of a service flow, the feature information of the service flow including a period of the service flow and a traffic size of the service flow; determining a bandwidth assignment interval and an authorized bandwidth size for a service carried by the service flow based on the feature information of the service flow; determining an issuing time sequence based on the period of the service flow, the bandwidth assignment interval and the authorized bandwidth size, the issuing time sequence including a plurality of issuing times; issuing the authorized bandwidth size at each of the issuing times. The present disclosure further provides a method for determining feature information of a service flow, an optical line terminal, a computing server, and a computer-readable medium.

### TECHNICAL FIELD

The present disclosure relates to the field of communications, and in particular, to a bandwidth assignment method, a method for determining feature information of a service flow, an Optical Line Terminal (OLT), a computing server, and a computer-readable medium.

### BACKGROUND

Currently, in a Passive Optical Network (PON), a Dynamically Bandwidth Assignment (DBA) technology is adopted for assigning an uplink bandwidth. There is a waiting delay in a process of assigning the bandwidth, and there is a bandwidth-free interval (i.e., an interval without a bandwidth) if a time-division multiplexing technology is used for assigning the bandwidth, which may introduce a delay jitter of carried services.

How to reduce an uplink delay and the delay jitter becomes a technical problem to be solved in the field.

### SUMMARY

Embodiments of the present disclosure provide a bandwidth assignment method, a method for determining feature information of a service flow, an OLT, a computing server, and a computer-readable medium.

As a first aspect of the present disclosure, there is provided a bandwidth assignment method, including: determining feature information of a service flow, the feature information of the service flow including a period of the service flow and a traffic size of the service flow; determining a bandwidth assignment interval and an authorized bandwidth size for a service carried by the service flow based on the feature information of the service flow; determining an issuing time sequence based on the period of the service flow, the bandwidth assignment interval and the authorized bandwidth size, the issuing time sequence including a plurality of issuing times; and issuing the authorized bandwidth size at each of the issuing times.

As a second aspect of the present disclosure, there is provided a method for determining feature information of a service flow, including: receiving the service flow and related dynamic bandwidth application data; determining the feature information of the service flow based on the service flow and the related dynamic bandwidth application data, the feature information of the service flow including a period of the service flow and a traffic size of the service flow.

As a third aspect of the present disclosure, there is provided an OLT, including: at least one first processor; a first memory having at least one first program stored thereon, the at least one first program, executed by the at least one first processor, causes the at least one first processor to implement the bandwidth assignment method described above.

As a fourth aspect of the present disclosure, there is provided a computing server, including: at least one second processor; a second memory having at least one second program stored thereon, the at least one second program, executed by the at least one second processor, causes the at least one second processor to implement the method for determining the feature information of the service flow as described above.

As a fifth aspect of the present disclosure, there is provided a computer-readable medium having at least one computer program stored thereon, the computer program, executed by a processor, causes the processor to implement at least one of the bandwidth assignment method or the method for determining the feature information of the service flow as described above.

Since most deterministic services are periodic, a service flow of the deterministic service is also periodic. Therefore, in the bandwidth assignment method provided in the present disclosure, the period of the service flow and the traffic size of the service flow (herein, the traffic size of the service flow refers to a burst traffic size of the service flow) are determined firstly, and then the bandwidth assignment interval and the authorized bandwidth size are determined based on the feature information of the service flow. Specifically, the bandwidth assignment interval is related to the period of the service flow, and the authorized bandwidth size is related to the traffic size of the service flow.

The issuing time sequence is determined based on the bandwidth assignment interval and the authorized bandwidth size, and the authorized bandwidth size is issued at each of the issuing times.

The issuing time of issuing the authorized bandwidth size is determined based on the period of the service flow, so that, before a next period of the service flow arrives, the bandwidth is assigned in time to the service flow upcoming, resulting in a reduced service delay and a reduced delay jitter. Moreover, the bandwidth assignment method can assign the bandwidth without resulting in an increased overhead, which facilitates to obtain an improved bandwidth utilization rate.

### BRIEF DESCRIPTION OF DRAWINGS

FIG. 1 is a flowchart of an implement of a bandwidth assignment method provided in a first aspect of the present disclosure;

FIG. 2 is a flowchart of an implement of a bandwidth assignment method provided in a first aspect of the present disclosure;

FIG. 3 is a schematic flowchart illustrating operation S110 of determining feature information of a service flow by a computing server;

FIG. 4 is a schematic flowchart illustrating operation S110 of determining feature information of a service flow by an OLT;

FIG. 5 is a schematic diagram illustrating interaction between an OLT and an ONU during the OLT determining feature information of a service flow;

FIG. 6 is a schematic diagram illustrating interaction between an OLT and an ONU during the ONU determining feature information of a service flow;

FIG. 7 is a schematic diagram illustrating interaction between an OLT and a computing server during the computing server determining feature information of a service flow;

FIG. 8 is a schematic diagram of an implement of operation S130 in a bandwidth assignment method provided in a first aspect of the present disclosure;

FIG. 9 is a schematic diagram of determining a period of a service flow in a process of dynamically assigning a bandwidth;

FIG. 10 is a schematic diagram of issuing an authorized bandwidth size in a bandwidth assignment method provided in a first aspect of the present disclosure;

FIG. 11 is a flowchart of an implementation of operation S131;

FIG. 12 is a schematic diagram of determining a time advance;

FIG. 13 is a schematic diagram of an implementation of a bandwidth assignment method provided in the present disclosure;

FIG. 14 is a flowchart of an implement of a method for determining feature information of a service flow provided in a second aspect of the present disclosure;

FIG. 15 is a partial flowchart of operation S220;

FIG. 16 is a flowchart of an implement of a method for determining feature information of a service flow provided in a second aspect of the present disclosure;

FIG. 17 is a block diagram of an implement of an OLT provided in the present disclosure;

FIG. 18 is a block diagram of an implement of a computing server provided in the present disclosure;

FIG. 19 is a schematic diagram of a computer readable medium provided in the present disclosure.

### DETAIL DESCRIPTION OF EMBODIMENTS

In order to make those skilled in the art better understand the technical solutions of the present disclosure, a bandwidth assignment method, a method for determining feature information of a service flow, an OLT, a computing server, and a computer-readable medium provided by the present disclosure, are described in detail below with reference to the accompanying drawings.

Exemplary embodiments are described more fully below with reference to the accompanying drawings, but the exemplary embodiments may be embodied in different forms, and the present disclosure should not be construed as limited to the embodiments set forth herein. The embodiments are provided to make the present disclosure thorough and complete, and for those skilled in the art fully understanding the scope of the present disclosure.

The embodiments of the present disclosure and the technical features in the embodiments may be combined with each other if no conflict is incurred.

As used in the present disclosure, a term “and/or” includes any and all combinations of at least one of listed items.

The terms used in the present disclosure are for a purpose of describing particular embodiments only, and are not intended to limit the present disclosure. As used in the present disclosure, singular forms “a” and “the” include plural forms as well, unless the context clearly defines otherwise. It should further be understood that terms “includes/comprises” and/or “made of/consisted of” in the present disclosure are used to specify a presence of at least one of recited features, integers, steps, operations, elements or components, but do not preclude a presence or an addition of at least one of other features, integers, steps, operations, elements, components or groups thereof.

Unless otherwise defined, meanings of all terms (including technical terms and scientific terms) used herein are the same as meanings commonly understood by one of ordinary skills in the art. It should further be understood that terms, such as those defined in common dictionaries, should be construed as having a meaning that is consistent with that in the background of the existing art and the present disclosure, and should not be construed as having an idealized or over-formal meaning, unless expressly defined in the present disclosure.

In a process of assigning a bandwidth in a PON network, a means for improving a delay mainly includes: a first means to reduce a scheduling period Tdba of DBA, a second means to adopt a fixed bandwidth assignment method, and a third means to improve an algorithm of DBA. However, the scheduling period Tdba is to be set by depending on service features, and a relatively smaller scheduling period Tdba causes a frequency of assigning the bandwidth to become relatively large, thereby reducing the bandwidth utilization rate. The adoption of the fixed bandwidth assignment method may result in an increased transmission overhead and a reduced bandwidth utilization rate. The third means may increase the complexity of the algorithm, thereby resulting in an increased cost of software and hardware.

Deterministic services have particularly high expectations for a delay and a delay jitter. It has been found that for typical deterministic services, most of the services are periodic, or are at least a combination of a periodic service and any other service.

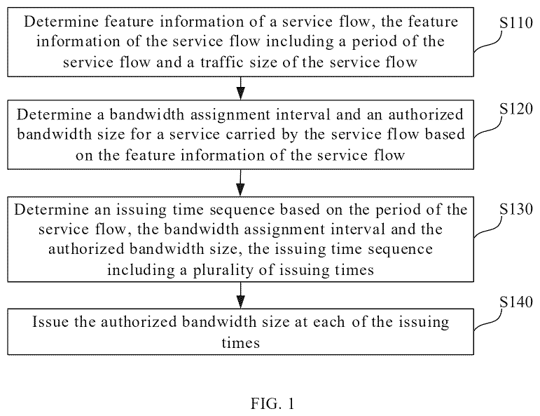

In view of above, as a first aspect of the present disclosure, there is provided a bandwidth assignment method, and as shown in FIG. 1, the bandwidth assignment method includes following operations S110 to S140.

At operation S110, determining feature information of a service flow, the feature information of the service flow including a period of the service flow and a traffic size of the service flow.

At operation S120, determining a bandwidth assignment interval and an authorized bandwidth size for a service carried by the service flow based on the feature information of the service flow.

At operation S130, determining an issuing time sequence based on the period of the service flow, the bandwidth assignment interval and the authorized bandwidth size, the issuing time sequence including a plurality of issuing times.

At operation S140, issuing the authorized bandwidth size at each of the issuing times.

The bandwidth assignment method provided in the first aspect of the present disclosure may be performed by an optical line terminal (OLT).

As described above, most deterministic services are periodic, and thus a service flow of the deterministic service is also periodic. Therefore, in the bandwidth assignment method provided in the present disclosure, the period of the service flow and the traffic size of the service flow (herein, the traffic size of the service flow refers to a burst traffic size of the service flow) are determined firstly, and then the bandwidth assignment interval and the authorized bandwidth size are determined based on the feature information of the service flow. Specifically, the bandwidth assignment interval is related to the period of the service flow, and the authorized bandwidth size is related to the traffic size of the service flow.

The issuing time sequence is determined based on the bandwidth assignment interval and the authorized bandwidth size, and the authorized bandwidth size is issued at each of the issuing times.

The issuing time of issuing the authorized bandwidth size is determined based on the period of the service flow, so that, before a next period of the service flow arrives, the bandwidth is assigned in time to the service flow upcoming, resulting in a reduced service delay and a reduced delay jitter. Moreover, the bandwidth assignment method can assign the bandwidth without resulting in an increased overhead, which facilitates to obtain an improved bandwidth utilization rate.

In the present disclosure, how to perform operation S110 is not particularly limited. For example, the period of the service flow may be determined by the OLT based on the received service flow. The service flow arrives periodically, and the OLT can determine the feature information of the service flow based on different times of receiving the service flow and the traffic size of the service flow at different times.

Certainly, the OLT may also send the received service flow to another computing server, and the computing server determines the feature information of the service flow based on the received service flow. In such case, operation S110 includes receiving data, related to the feature information of the service flow, sent by the computing server, and the feature information of the service flow is obtained by analyzing the data related to the feature information of the service flow.

In addition, the ONU may also determine the feature information of the service flow. In the implementation, the determining feature information of a service flow includes: receiving initial feature information of the service flow reported by an optical network unit; and determining the feature information of the service flow based on the initial feature information of the service flow.

In some implementations, the initial feature information of the service flow may be directly taken as the feature information of the service flow. Alternatively, the initial feature information of the service flow may also be further processed to obtain the feature information of the service flow. These are described below, and thus are not illustrated here.

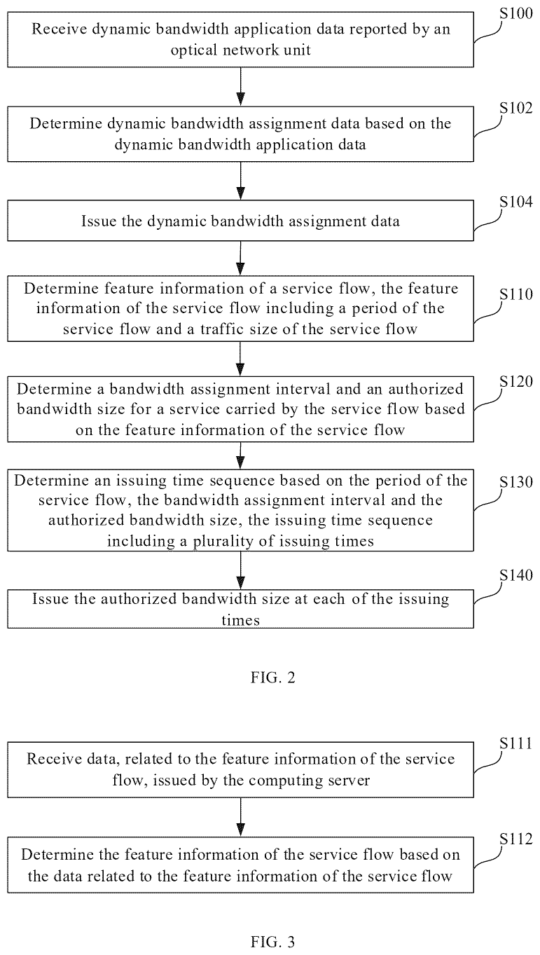

As shown in FIG. 2, in either case, before determining the feature information of the service flow, the bandwidth assignment method further includes following operation S100.

At operation S100, receiving dynamic bandwidth application data reported by an optical network unit (ONU).

In the present disclosure, the ONU reports the dynamic bandwidth application data at intervals. Therefore, before operation S110, a dynamic bandwidth may be assigned to the service by means of DBA. Therefore, the bandwidth assignment method may further include following operations S102 to S104.

At operation S102, determining dynamic bandwidth assignment data based on the dynamic bandwidth application data.

At operation S104, issuing the dynamic bandwidth assignment data.

Operations S110 to S140 may be regarded as a fixed bandwidth assignment scheme, and before performing operations S110 to S140, a bandwidth may be first assigned to the service flow based on such dynamic bandwidth assignment scheme, so that a continuity of service can be ensured.

For a case where the computing server other than the OLT determines the feature information of the service flow, before determining the feature information of the service flow, the bandwidth assignment method further includes following operation S101.

At operation S101, reporting the received service flow to a computing server.

Accordingly, as shown in FIG. 3, the determining feature information of a service flow includes following operations S111 and S112.

At operation S111, receiving data, related to the feature information of the service flow, issued by the computing server.

At operation S112, determining the feature information of the service flow based on the data related to the feature information of the service flow.

In the present disclosure, the specific type of the computing server is not particularly limited, and the computing server at least has a computing capability, and can determine the feature information of the service flow based on the received service flow. By using the dedicated computing server for determining the feature information of the service flow, a more accurate computed result can be obtained, and thus the feature information of the service flow can be determined more accurately.

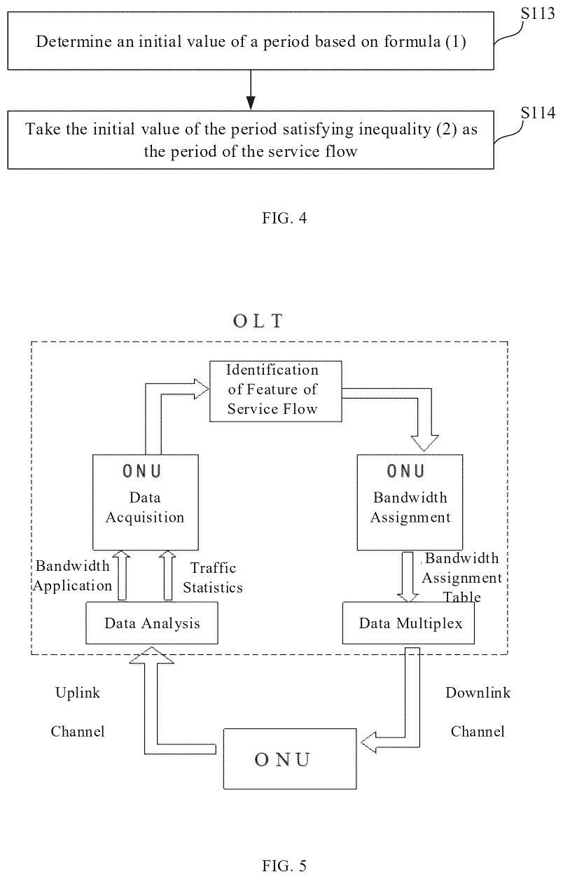

As described above, the OLT may also perform a task of computing for determining the feature information of the service flow. That is, as shown in FIG. 4, the determining feature information of a service flow may specifically include following operations S113 and S114.

At operation S113, determining an initial value of a period based on following formula (1).

At operation S114, taking the initial value of the period satisfying following inequality (2) as the period of the service flow.

$$P = N * Tdba / M \qquad ( 1 )$$

$$\vert P - Ave ( B 1 , … , BM - 1 ) \vert < Delt 1 \qquad ( 2 )$$

P is the initial value of the period; Tdba is a duration of a dynamic bandwidth scheduling period; N is a total number of dynamic bandwidth scheduling periods; M is a total number of bandwidth assignments that have already been performed; B1, . . . . BM−1 are respectively time intervals between M times of bandwidth assignments; and
Delt1 is a first threshold.

It should be noted that the initial value of the period is calculated every time the service flow is received. With periodic transmission of the service flow, the initial value P of the period obtained by the calculation of formula (1) changes.

In the present disclosure, if a difference between the calculated initial value P of the period and an average value of M−1 time intervals between the bandwidth assignments is less than the first threshold, it indicates that the current initial value P of the period is already relatively close to the average value of the time intervals between the bandwidth assignments, and the current initial value P of the period may be regarded as the period of the service flow.

As described above, for a device (e.g., the OLT or the computing server) for calculating the period of the service flow, the more times the service flow is received, the more accurately the period of the service flow can be determined. That is, the more times the bandwidth is assigned, the easier the period of the service flow can be counted statistically. Therefore, the larger M is, the easier it is to determine the period of the service flow. In some implementations, M>3.

In the present disclosure, a value of the first threshold Delt1 is not particularly limited. In some implementations, the value of the first threshold Delt1 may not exceed the order of 1/1000 of the initial value P of the period. The specific value of the first threshold Delt1 is determined based on a service scenario and a specific service type. The higher the precision that the service expects is, the smaller the value of the first threshold Delt1 is.

As described above, the initial feature information of the service flow may be determined by the ONU. The ONU enables a time stamp to be carried in the service flow and sends the initial feature information of the service flow with the time stamp in a message mode to the OLT through an uplink channel. The OLT determines the initial feature information of the service flow by means of data analyzing and message capturing.

Specifically, the determining the feature information of the service flow based on the initial feature information of the service flow includes: analyzing the received initial feature information of the service flow, and determining a time stamp carried by the initial feature information of the service flow; determining an initial value of a period based on following formula (1); determining a period of the optical network unit reporting the service flow; taking the initial value of the period satisfying following inequalities (3) and (4) as the period of the service flow;

$$P = N * Tdba / M , \qquad ( 1 )$$

$$\vert P - Ponu \vert < Delt 2 , \qquad ( 3 )$$

$$\vert Ave ( G 1 , … , GM ) - Gonu \vert < Delt 3. \qquad ( 4 )$$

P is the initial value of the period; Ponu is the period of the optical network unit reporting the service flow; G1, . . . , GM are respectively sizes of bandwidths of M times of bandwidth assignments; Gonu is a bandwidth size for a burst traffic reported by the optical network unit; Tdba is a duration of a dynamic bandwidth scheduling period; N is a total number of dynamic bandwidth scheduling periods; M is a total number of bandwidth assignments that have already been performed; Delt2 is a second threshold; and Delt3 is a third threshold.

In the present disclosure, neither the second threshold Delt2, nor the third threshold Delt3 is specifically limited. For example, the second threshold Delt2 may be on the order of 1/1000 of the initial value P of the period; the third threshold Delt3 may be on the order of 1/1000 of Gonu.

Three implementations of determining the feature information of the service flow are described below with reference to FIGS. 5 to 7.

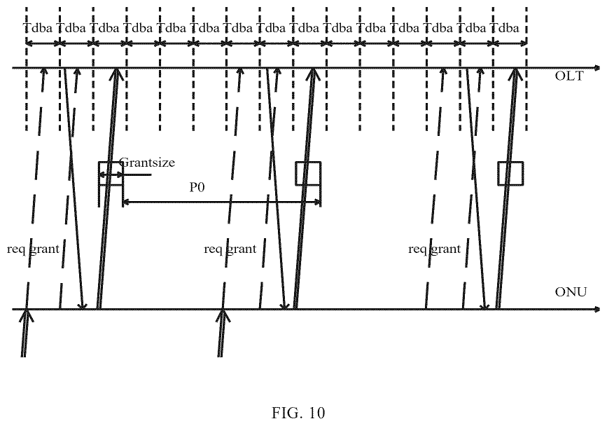

As shown in FIG. 5, the feature information of the service flow is determined by the OLT. The ONU sends the service flow and the dynamic bandwidth application data to the OLT through the uplink channel. The OLT analyzes the received data to obtain the service flow and the dynamic bandwidth application data. The service flow is determined to perform traffic statistics, data acquisition is performed on the data flow reported by the ONU and the feature information of the service flow is determined. A fixed bandwidth assignment result (including the authorized bandwidth size and the issuing time sequence) is determined based on the feature information of the service flow. Through a form of a bandwidth assignment table, the fixed bandwidth assignment result is issued to the ONU. FIG. 9 shows a process of determining the period of the service flow in a process of dynamic bandwidth assignment. As shown in FIG. 9, double solid arrows represent service flows; dotted arrows represent dynamic bandwidth assignment results (req grant). In the process of dynamic bandwidth assignment, the period of the service flow can be determined. FIG. 10 is a schematic diagram of issuing an authorized bandwidth size Grantsize after determining a duration P0 of the period of the service flow.

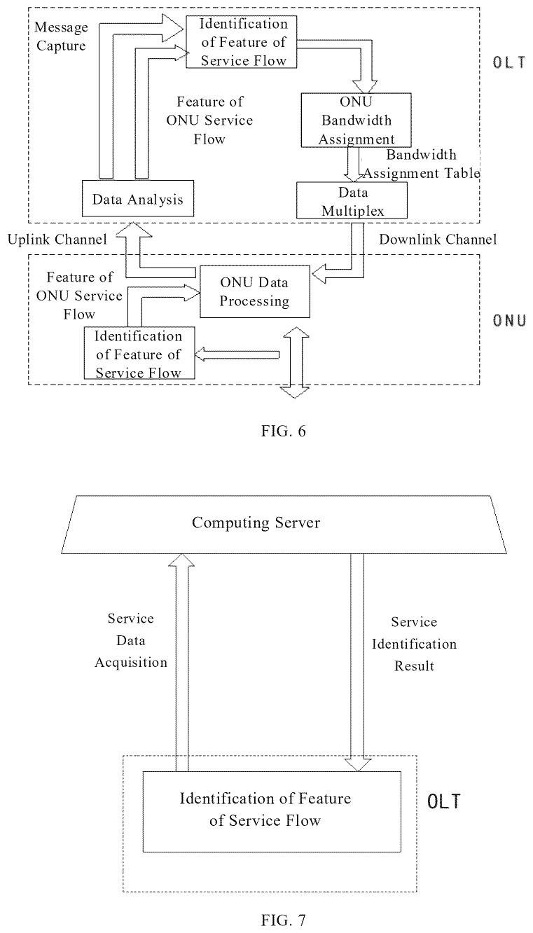

As shown in FIG. 6, the ONU enables the time stamp to be carried in the service flow, and sends the service flow with the time stamp to the OLT through the uplink channel. The OLT determines the feature information of the service flow by means of data analyzing and message capturing. The fixed bandwidth assignment result (including the authorized bandwidth size and the issuing time sequence) is determined based on the feature information of the service flow. Through a form of a bandwidth assignment table, the fixed bandwidth assignment result is issued to the ONU. In the implementations, the ONU may mark the times tamp on a service message through a message protocol. Specifically, key parameters defined by the protocol may include: Fonu, an identifier of the service flow determined by the ONU; Ponu, a period of the service flow determined by the ONU; Gonu, a bandwidth assignment size for a burst traffic determined by the ONU; Eonu, whether the ONU determines a new parameter of the service flow (yes or no).

The protocol described above may be sent based on a PLOAM or OMCI channel of GPON series or an OAM message of EPON. The format of the message complies with established standards (GPON series or EPON series). The message may be sent periodically or may be updated and sent in response to determining that the information changes. In this way, a disadvantage that the period of DBA cannot be set to be too large can be avoided.

As shown in FIG. 7, an operation of determining the feature information of the service flow is performed by the computing server. The OLT uploads the service flow to the computing server, and the computing server sends data carrying the feature information of the service flow to the OLT.

In the present disclosure, the bandwidth assignment result carries the authorized bandwidth size. In the present disclosure, how to perform operation S120 is not particularly limited. In some implementations, in operation S120, the authorized bandwidth size may be calculated according to following formula (5):

$$GrandSize = Ave ( G 1 , … , GM ) + Gs . \qquad ( 5 )$$

GrandSize is the authorized bandwidth size; G1, . . . , GM are respectively bandwidth sizes of M times of bandwidth assignments; Gs is a bandwidth margin.

In the present disclosure, how to determine the bandwidth margin Gs is not particularly limited. The bandwidth margin Gs may be determined based on the specific service type and the service scenario. In some implementations, 5% to 10% of Ave (G1, . . . , GM) may be taken as the bandwidth margin Gs.

In the present disclosure, how to determine the issuing times is not particularly limited. In the present disclosure, by determining the period of the service flow, a prediction for an arrival time of the service flow can be realized. The issuing time for issuing the fixed bandwidth assignment result is set before the arrival time of the service flow, and a time interval between the issuing time and the corresponding arrival time of the service flow should not be too long.

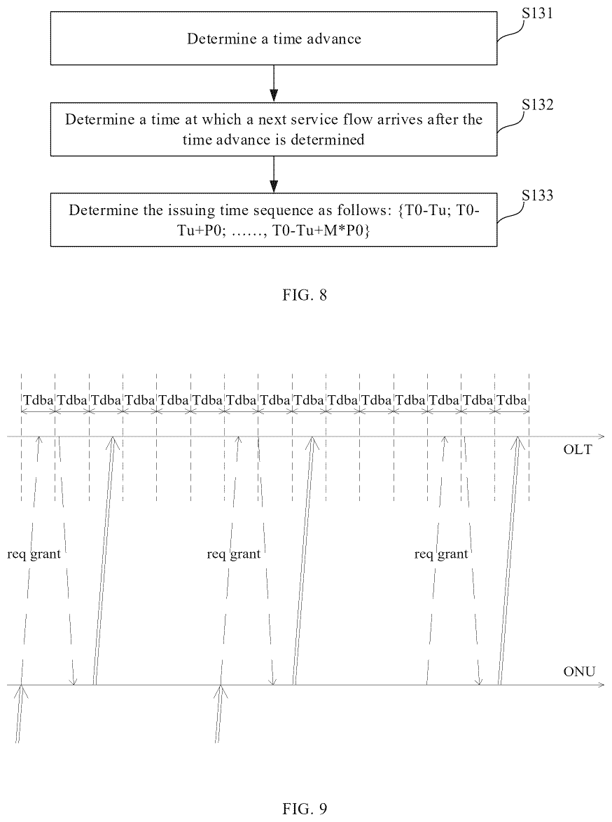

In some implementations, as shown in FIG. 8, operation S130 may include following operations S131 to S133.

At operation S131, determining a time advance.

At operation S132, determining a time at which a next service flow arrives after the time advance is determined.

At operation S133, determining the issuing time sequence as follows: {T0−Tu; T0−Tu+P0; . . . , T0−Tu+M*P0}.

T0 is the time at which the next service flow arrives after the time advance is determined; Tu is the time advance; M is a total number of bandwidth assignments that have already been performed; P0 is a duration of the period of the service flow.

In the present disclosure, how to quickly determine the issuing time sequence is not particularly limited. In some implementations, the issuing time sequence may be quickly assigned by a hardware counter. That is, there is a time sequence with a length of N dynamic bandwidth assignment scheduling periods Tdba, i.e., M periods of the service flow, and in hardware, the issuing time sequence is increased according to a certain step size.

Certainly, the present disclosure is not limited thereto, and the issuing time sequence may also be determined in a software manner.

In a case where an upstream of the service flow reaches a stable state, the service bandwidth assignment method provided in the present disclosure may be executed. In the service bandwidth assignment method provided in the present disclosure, an assignment of bandwidth is fixed, a period of assignment is fixed, and a delay and a delay jitter are fixed. In the state of “the upstream of the service flow reaches the stable state”, the dynamic bandwidth application data of the ONU is also fixed. Based on the stable state, the time advance is assigned for the bandwidth assignment. In some implementations, the time advance is an integer multiple of the dynamic bandwidth scheduling period Tdba.

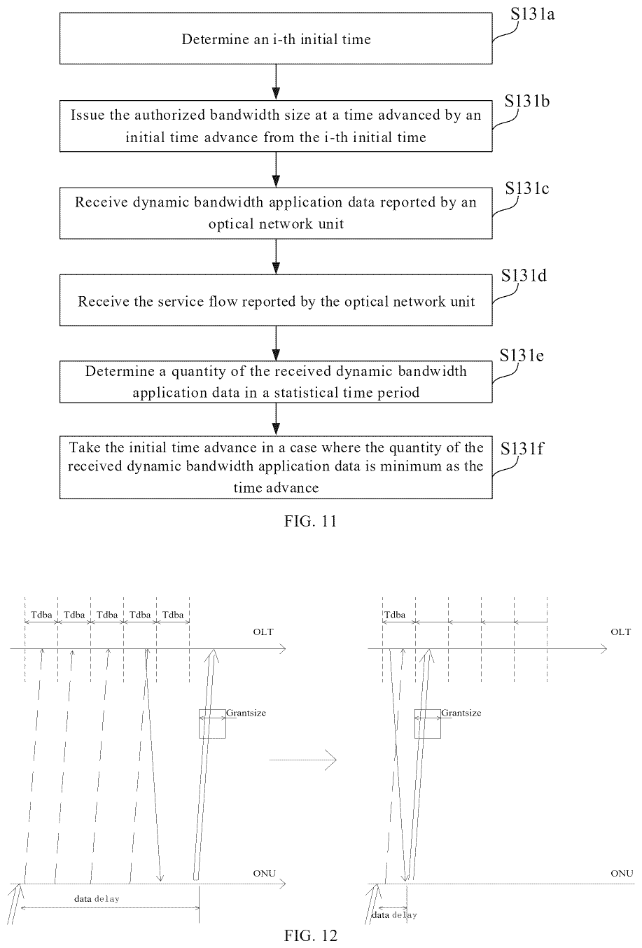

The time advance may be determined in a stepwise adjustment manner. Specifically, as shown in FIG. 11, operation S131 may include following operations S131a to S131e.

At operation S131a, determining an i-th initial time, the i-th initial time being the time at which the next service flow arrives.

At operation S131b, issuing the authorized bandwidth size at a time advanced by an initial time advance from the i-th initial time, the initial time advance being iTdba.

At operation S131c, receiving dynamic bandwidth application data reported by an optical network unit.

At operation S131d, receiving the service flow reported by the optical network unit.

At operation S131e, determining a quantity of the received dynamic bandwidth application data in a statistical time period, the statistical time period being a time duration between a time of currently issuing the authorized bandwidth size and a time of receiving the service flow; i being sequentially taken from 1, 2, . . . n, and n being a positive integer greater than 2.

Operations S131a to S131e are performed n times in total. After n cycles are completed, the determining a time advance further includes following an operation S131f.

At operation S131f, taking the initial time advance in a case where the quantity of the received dynamic bandwidth application data is minimum as the time advance.

Above operations S131a to S131f are exemplarily described below by taking n=4 as an example.

Taking i=1, the time at which the next service flow arrives may be determined to be to based on the period of the service flow. The bandwidth assignment result is issued at a time of 10-Tdba. After receiving the service flow, the quantity of the received dynamic bandwidth application data in the statistical time period from the time of issuing the bandwidth assignment result to the time of receiving the service flow is counted, and is denoted as n1.

Taking i=2, the time at which the next service flow arrives may be determined to be t2 based on the period of the service flow. The bandwidth assignment result is issued at a time of t2-2Tdba. After receiving the service flow, the quantity of the received dynamic bandwidth application data in the statistical time period from the time of issuing the bandwidth assignment result to the time of receiving the service flow is counted, and is denoted as n2.

Taking i=3, the time at which the next service flow arrives may be determined to be t3 based on the period of the service flow. The bandwidth assignment result is issued at a time of t3-3Tdba. After receiving the service flow, the quantity of the received dynamic bandwidth application data in the statistical time period from the time of issuing the bandwidth assignment result to the time of receiving the service flow is counted, and is denoted as n3,

Taking i=4, the time at which the next service flow arrives may be determined to be t4 based on the period of the service flow. The bandwidth assignment result is issued at a time of t4-4Tdba. After receiving the service flow, the quantity of the received dynamic bandwidth application data in the statistical time period from the time of issuing the bandwidth assignment result to the time of receiving the service flow is counted, and is denoted as n4.

Comparing n1, n2, n3 and n4 with each other, the time advance corresponding to the smallest one of them is taken as the time advance. For example, if n4 is minimum, the time advance is 4Tdba; if n3 is minimum, the time advance is 3Tdba; if n2 is minimum, the time advance is 2Tdba; if n1 is minimum, the time advance is Tdba.

As shown in FIG. 12, the authorized bandwidth assignment result may be issued before the service flow arrives by adjusting the time advance.

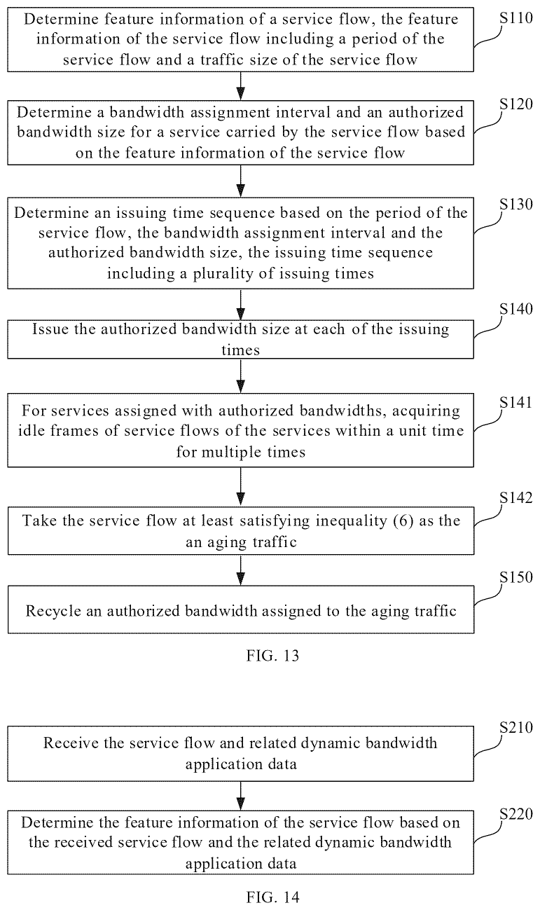

In the present disclosure, in order to avoid an invalid bandwidth assignment after the service flow stops, a fixed bandwidth (i.e., authorized bandwidth) assigned to an aging traffic may be reclaimed. Accordingly, in some implementations, as shown in FIG. 13, the bandwidth assignment method further includes following operation S150.

At operation S150, recycling an authorized bandwidth assigned to an aging traffic.

In the present disclosure, the aging traffic is not particularly limited, and any traffic of a service is to be referred to as the aging traffic as long as the traffic of the service cannot be restored to an original state, in which there is a fixed traffic in each period of the service, within a certain time duration.

In some implementations, before recycling the authorized bandwidth assigned to the aging traffic, the bandwidth assignment method further includes following operations S141 and S142.

At operation S141, for services assigned with authorized bandwidths, acquiring idle frames of service flows of the services within a unit time for multiple times.

At operation S142, taking the service flow at least satisfying following inequality (6) as the aging traffic.

$$Ave ( K 1 , K 2 , … , Km ) - K 0 > Delt 4 \qquad ( 6 )$$

In the inequality (6), m is acquisition times; K1, K2, . . . Km are respectively a total number of idle frames within the unit time acquired at a first time, a total number of idle frames within the unit time acquired at a second time, . . . , and a total number of idle frames within the unit time acquired at an m-th time; K0 is a standard value of the number of idle frames within the unit time; Delt4 is a fourth threshold.

In the present disclosure, the fourth threshold is not particularly limited, and may be determined according to the specific service scenario and the specific service type.

For GPON, in operation S142, the service flow satisfying both inequalities (6) and (7) is taken as the aging traffic:

$$L 0 - Ave ( L 1 , L 2 , … , Lm ) > Delt 5. \qquad ( 7 )$$

L0 is a total traffic of data of the service flow; L1, L2, . . . , Lm are respectively a data traffic of the service flow acquired at a first time, a data traffic of the service flow acquired at a second time, . . . , and a data traffic of the service flow acquired at an m-th time; Delt5 is a fifth threshold.

In the present disclosure, the value of the fifth threshold is not particularly limited. The fifth threshold Delt5 may be determined based on specific application scenarios and service expectations. In some implementations, the value of Delt5 may range from L0/10 to L0/5. Further, Delt5 may be L0/10.

As a second aspect of the present disclosure, there is provided a method for determining feature information of a service flow, and as shown in FIG. 14, the method includes following operations S210 and S220.

At operation S210, receiving the service flow and related dynamic bandwidth application data.

At operation S220, determining feature information of the service flow based on the service flow and the related dynamic bandwidth application data, the feature information of the service flow including a period of the service flow and a traffic size of the service flow.

The method for determining the feature information of the service flow in the present disclosure may be performed by a computing server. After the period of the service flow is calculated and obtained, the data carrying the period of the service flow is sent to the OLT, so as to allow the OLT to perform a bandwidth assignment.

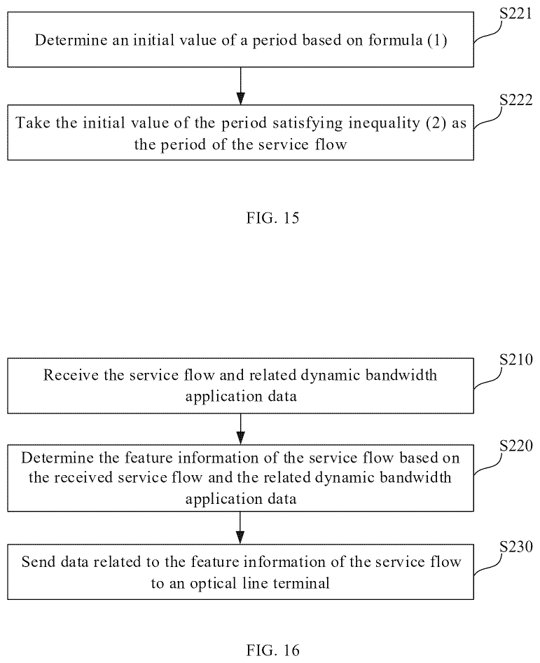

In some implementations, as shown in FIG. 15, in operation S220, the determining feature information of the service flow based on the service flow and the related dynamic bandwidth application data may include following operations S221 and S222.

At operation S221, determining an initial value of a period based on following formula (1).

At operation S222, taking the initial value of the period satisfying following inequality (2) as the period of the service flow;

$$P = N * Tdba / M , \qquad ( 1 )$$

$$\vert P - Ave ( B 1 , … , BM - 1 ) \vert < Delt 1. \qquad ( 2 )$$

P is the initial value of the period; Tdba is a duration of a dynamic bandwidth scheduling period; N is a total number of dynamic bandwidth scheduling periods; M is a total number of bandwidth assignments that have already been performed; B1, BM−1 are respectively time intervals between M times of bandwidth assignments; Delt1 is a first threshold.

As described above, in the present disclosure, the value of the first threshold Delt1 is not particularly limited. In some implementations, the value of the first threshold Delt1 may not exceed the order of 1/1000 of the initial value P of the period. The specific value of the first threshold Delt1 is determined based on a service scenario and a specific service type. The higher the precision that the service expects is, the smaller the value of the first threshold Delt1 is.

As shown in FIG. 16, after determining the feature information of the service flow, the method for determining feature information of a service flow may further include following operation S230.

At operation S230, sending data related to the feature information of the service flow to an optical line terminal, the data related to the feature information of the service flow carrying the feature information of the service flow.

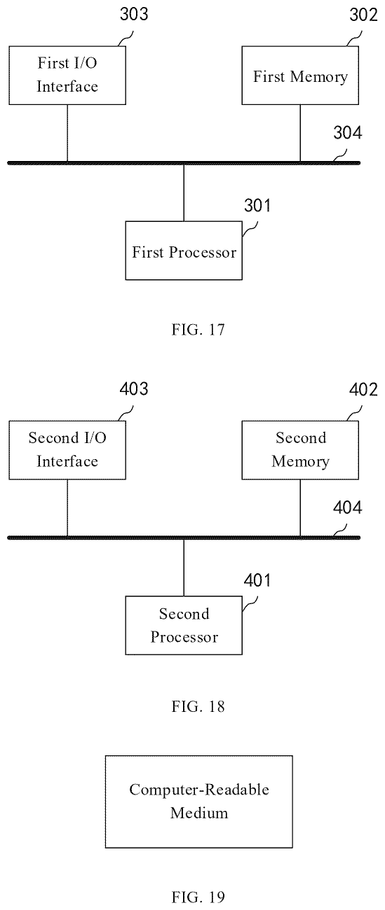

As a third aspect of the present disclosure, there is provided an optical line terminal, and as shown in FIG. 17, the optical line terminal includes: at least one first processor 301; and a first memory 302 having at least one first program stored thereon, the at least one first program, executed by the at least one first processor 301, causes the at least one first processor 301 to implement the bandwidth assignment method described above.

In some implementations, the optical line terminal may further include at least one first I/O interface 303 connected between the first processor 301 and the first memory 302, and configured to implement information interaction between the first processor 301 and the first memory 302.

The first processor 301 is a device having a capability of processing data, includes, but is not limited to, a Central Processing Unit (CPU), and the like; the first memory 302 is a device having a capability of storing data, includes, but is not limited to, a random access memory (RAM, in particular, SDRAM, DDR, and the like), a read only memory (ROM), an electrically erasable programmable read only memory (EEPROM), and a FLASH; the first I/O interface (read/write interface) 303 is connected between the first processor 301 and the first memory 302, enables to implement information interaction between the first processor 301 and the first memory 302, and includes, but is not limited to, a data Bus, and the like.

In some implementations, the first processor 301, the first memory 302, and the first I/O interface 303 are connected together through a first bus 304, and are further connected to other components of a computing device.

As a fourth aspect of the present disclosure, there is provided a computing server, and as shown in FIG. 18, the computing server including: at least one second processor 401; a second memory 402 having at least one second program stored thereon, the at least one second program, executed by the at least one second processor 401, causes the at least one second processor 401 to implement the method for determining feature information of the service flow as described above.

In some implementations, the computing server may further include at least one second I/O interface 403 connected between the second processor 401 and the second memory 402, and configured to implement information interaction between the second processor 401 and the second memory 402.

The second processor 401 is a device having a capability of processing data, includes, but is not limited to, a Central Processing Unit (CPU), and the like; the second memory 402 is a device having a capability of storing data, includes, but is not limited to, a random access memory (RAM, in particular, SDRAM, DDR, and the like), a read only memory (ROM), an electrically erasable programmable read only memory (EEPROM), and a FLASH; the second I/O interface (read/write interface) 403 is connected between the second processor 401 and the second memory 402, enables to implement information interaction between the second processor 401 and the second memory 402, and includes, but is not limited to, a data Bus, and the like.

In some implementations, the second processor 401, the second memory 402, and the second I/O interface 403 are connected together through a second bus 404, and are further connected to other components of a computing device.

As a fifth aspect of the present disclosure, as shown in FIG. 19, there is provided a computer-readable medium having at least one computer program stored thereon, the computer program, executed by a processor, causes the processor to implement the method described above.

It should be understood by those of ordinary skill in the art that all or some of the operations in the method described above, or all or some of the functional modules/components in the system or apparatus described above may be implemented as software, firmware, hardware, or suitable combinations thereof. In a hardware implementation, the division between the functional modules/components stated above does not correspond to the division of physical components; for example, one physical component may have a plurality of functions, or one function or operation may be performed through a cooperation of several physical components. Some or all of the physical components may be implemented as software executed by a processor, such as a central processing unit, a digital signal processor or a microprocessor, or may be implemented as hardware, or may be implemented as an integrated circuit, such as an application specific integrated circuit. Such software may be distributed on a computer-readable medium, the computer-readable medium may include computer storage medium (or non-transitory medium) and communication medium (or transitory medium). As known to those skilled in the art, the computer storage medium includes volatile/nonvolatile or removable/non-removable medium used in any method or technology for storing information (such as computer-readable instructions, data structures, program modules and other data). The computer storage medium includes, but is not limited to, RAM, ROM, EEPROM, a flash memory or other memory techniques, CD-ROM, a Digital Video Disk (DVD) or other optical discs, magnetic cassettes, magnetic tapes, magnetic disks or other magnetic storage devices, or any other medium which can be used to store the desired information and can be accessed by a computer. In addition, as known to those skilled in the art, the communication medium generally includes computer-readable instructions, data structures, program modules or other data in a modulated data signal, such as a carrier wave or other transmission mechanism, and may include any information delivery medium.

The present disclosure discloses the exemplary embodiments, and although specific terms are employed, they are used and should only be interpreted in a generic and descriptive meaning and not for purposes of a limitation. In some examples, it is apparent to those skilled in the art that features, characteristics and/or elements described in connection with specific embodiments may be used alone or in combination with features, characteristics and/or elements described in connection with other embodiments, unless explicitly stated otherwise. Therefore, it should be understood by those skilled in the art that various changes in form and details may be made without departing from the scope of the present disclosure as set forth in the appended claims.

1. A bandwidth assignment method, comprising:
determining feature information of a service flow, the feature information of the service flow comprising a period of the service flow and a traffic size of the service flow;
determining a bandwidth assignment interval and an authorized bandwidth size for a service carried by the service flow based on the feature information of the service flow;
determining an issuing time sequence based on the period of the service flow, the bandwidth assignment interval and the authorized bandwidth size, the issuing time sequence comprising a plurality of issuing times;
issuing the authorized bandwidth size at each of the issuing times.

2. The method of claim 1, wherein, before the determining feature information of a service flow, the method further comprises:
receiving dynamic bandwidth application data reported by an optical network unit;
determining dynamic bandwidth assignment data based on the dynamic bandwidth application data; and
issuing the dynamic bandwidth assignment data.

3. The method of claim 1, wherein, before the determining feature information of a service flow, the method further comprises:
reporting the service flow to a computing server;
the determining feature information of a service flow comprises:
receiving data, related to the feature information of the service flow, issued by the computing server;
determining the feature information of the service flow based on the data related to the feature information of the service flow.

4. The method of claim 1, wherein the determining feature information of a service flow comprises:
receiving initial feature information of the service flow reported by an optical network unit;
determining the feature information of the service flow based on the initial feature information of the service flow.

5. The method of claim 2, wherein the determining feature information of a service flow comprises:
determining an initial value of a period based on formula (1);
taking the initial value of the period satisfying inequality (2) as the period of the service flow;
$$P = N * Tdba / M , \qquad ( 1 )$$
$$\vert P - Ave ( B 1 , … , BM - 1 ) \vert < Delt 1 , \qquad ( 2 )$$
wherein P is the initial value of the period;
Tdba is a duration of a dynamic bandwidth scheduling period;
N is a total number of dynamic bandwidth scheduling periods;
M is a total number of bandwidth assignments that have already been performed;
B1, . . . , BM−1 are respectively time intervals between M times of bandwidth assignments;
Delt1 is a first threshold.

6. The method of claim 4, wherein the determining the feature information of the service flow based on the initial feature information of the service flow comprises:
analyzing the initial feature information of the service flow, and determining a time stamp carried by the initial feature information of the service flow;
determining an initial value of a period based on formula (1);
determining a period of the optical network unit reporting the service flow;
taking the initial value of the period satisfying inequalities (3) and (4) as the period of the service flow;
$$P = N * Tdba / M , \qquad ( 1 )$$
$$\vert P - Ponu \vert < Delt 2 , \qquad ( 3 )$$
$$\vert Ave ( G 1 , … , GM ) - Gonu \vert < Delt 3 , \qquad ( 4 )$$
wherein P is the initial value of the period;
Ponu is the period of the optical network unit reporting the service flow;
G1, . . . , GM are respectively bandwidth sizes of M times of bandwidth assignments;
Gonu is a bandwidth size for a burst traffic reported by the optical network unit;
Tdba is a duration of a dynamic bandwidth scheduling period;
N is a total number of dynamic bandwidth scheduling periods;
M is a total number of bandwidth assignments that have already been performed;
Delt2 is a second threshold;
Delt3 is a third threshold.

7. The method of claim 1, wherein in the determining a bandwidth assignment interval and an authorized bandwidth size for a service carried by the service flow based on the feature information of the service flow, the authorized bandwidth size is calculated according to formula (5):
$$GrandSize = Ave ( G 1 , … , GM ) + Gs , \qquad ( 5 )$$
wherein, GrandSize is the authorized bandwidth size;
G1, . . . , GM are respectively bandwidth sizes of M times of bandwidth assignments;
Gs is a bandwidth margin.

8. The method of claim 1, wherein the determining an issuing time sequence based on the period of the service flow, the bandwidth assignment interval and the authorized bandwidth size comprises:
determining a time advance;
determining a time at which a next service flow arrives after the time advance is determined;
determining the issuing time sequence as follows:
$$\{ T 0 - Tu ; T 0 - Tu + P 0 ; … , T 0 - Tu + M * P 0 \} ;$$
wherein, T0 is the time at which the next service flow arrives after the time advance is determined;
Tu is the time advance;
M is a total number of bandwidth assignments that have already been performed;
P0 is a duration of the period of the service flow.

9. The method of claim 8, wherein the time advance is an integer multiple of the dynamic bandwidth scheduling period.

10. The method of claim 9, wherein the determining a time advance comprises:
determining an i-th initial time, the i-th initial time being the time at which the next service flow arrives;
issuing the authorized bandwidth size at a time advanced by an initial time advance from the i-th initial time, the initial time advance being iTdba;
receiving dynamic bandwidth application data reported by an optical network unit;
receiving the service flow reported by the optical network unit;
determining a quantity of the dynamic bandwidth application data in a statistical time period, the statistical time period being a time duration between a time of currently issuing the authorized bandwidth size and a time of receiving the service flow; i being sequentially taken from 1, 2, . . . n, and n being a positive integer greater than 2;
the determining a time advance further comprises:
taking the initial time advance, in response to the quantity of the dynamic bandwidth application data being minimum, as the time advance.

11. The method of claim 1, further comprising:
recycling an authorized bandwidth assigned to an aging traffic.

12. The method of claim 11, wherein, before the recycling an authorized bandwidth assigned to an aging traffic, the method further comprises:
for services assigned with authorized bandwidths, acquiring idle frames of service flows of the services within a unit time for multiple times;
taking the service flow at least satisfying inequality (6) as the aging traffic:
$$Ave ( K 1 , K 2 , … , Km ) - K 0 > Delt 4 , \qquad ( 6 )$$
wherein m is acquisition times;
K1, K2, . . . , Km are respectively a total number of idle frames within the unit time acquired at a first time, a total number of idle frames within the unit time acquired at a second time, . . . , and a total number of idle frames within the unit time acquired at an m-th time;
K0 is a standard value of the number of idle frames within the unit time;
Delt4 is a fourth threshold.

13. The method of claim 12, wherein in the taking the service flow at least satisfying inequality (6) as the aging traffic, the service flow satisfying both inequalities (6) and (7) is taken as the aging traffic:
$$L 0 - Ave ( L 1 , L 2 , … , Lm ) > Delt 5 , \qquad ( 7 )$$
wherein L0 is a total traffic of data of the service flow;
L1, L2, . . . , Lm are respectively a data traffic of the service flow acquired at a first time, a data traffic of the service flow acquired at a second time, . . . , and data traffic of the service flow acquired at an m-th time;
Delt5 is a fifth threshold.

14. A method for determining feature information of a service flow, comprising:
receiving the service flow and related dynamic bandwidth application data;
determining the feature information of the service flow based on the service flow and the related dynamic bandwidth application data, the feature information of the service flow comprising a period of the service flow and a traffic size of the service flow.

15. The method of claim 14, wherein in the determining the feature information of the service flow based on the service flow and the related dynamic bandwidth application data, determining the period of the service flow based on the service flow and the related dynamic bandwidth application data comprises:
determining an initial value of a period based on formula (1);
taking an initial value of the period satisfying inequality (2) as the period of the service flow;
$$P = N * Tdba / M , \qquad ( 1 )$$
$$\vert P - Ave ( B 1 , … , BM - 1 ) \vert < Delt 1 , \qquad ( 2 )$$
wherein P is the initial value of the period;
Tdba is a duration of a dynamic bandwidth scheduling period;
N is a total number of dynamic bandwidth scheduling periods;
M is a total number of bandwidth assignments that have already been performed;
B1, . . . , BM−1 are respectively time intervals between M times of bandwidth assignments;
Delt1 is a first threshold.

16. The method of claim 14, further comprising:
sending data related to the feature information of the service flow to an optical line terminal, the data related to the feature information of the service flow carrying the feature information of the service flow.

17. An optical line terminal, comprising:
at least one first processor;
a first memory having at least one first program stored thereon, the at least one first program, executed by the at least one first processor, causes the at least one first processor to implement the bandwidth assignment method of claim 1.

18. A computing server, comprising:
at least one second processor;
a second memory having at least one second program stored thereon, the at least one second program, executed by the at least one second processor, causes the at least one second processor to implement the method of claim 1.

19. A computer-readable medium having at least one computer program stored thereon, the computer program, executed by a processor, causes the processor to implement the method of claim 1.

20. A computer-readable medium having at least one computer program stored thereon, the computer program, executed by a processor, causes the processor to implement the method of claim 14.
